(19) United States
(12) Patent Application Publication
(10) Pub. No.: US 2001/0044372 A1
(43) Pub. Date: Nov. 22, 2001

(54) Soft chemistry resynthesis route to faujasitic and related FCC catalyst promoters (LAW529)

(76) Inventors: David E.W. Vaughan, Flemington, NJ (US); Karl G. Strohmaier, Port Murray, NJ (US)

Correspondence Address: ExxonMobil Research and Engineering Company, P. O. Box 900, Annandale, NJ, 08801-0900, US

(21) Appl. No.: 09/853,766

(22) Filed: May 11, 2001

Related U.S. Application Data
(63) Continuation of application No. 09/169,652, filed on Oct. 9, 1998, now abandoned.

(51) Int. Cl. B01J 29/08; B01J 29/04; B01J 29/00

(52) U.S. Cl. 502/61; 502/79; 502/75

(57) ABSTRACT

The present invention is a process for converting a hydrocarbon feedstream by a catalytic reaction in a catalytic cracking process comprising contacting said feedstream with a demetallated molecular sieve catalyst prepared by first synthesizing the molecular sieve in a metal aluminosilicate form, wherein the metal is Fe, Ga, Zn, B, Cr, Ni or Co and mixtures thereof, removal of the template, if present, by calcination, extracting the metal, with partial extraction of Al, cation exchange to reduce the residual base cation level to less than 1% wt; and catalyst fabrication by mixing the exchanged molecular sieve, optionally adding a secondary promoter, with a binder and forming.

### BACKGROUND OF THE INVENTION

The present invention relates to an improved fluidized-bed catalytic cracking (FCC) catalyst. In particular, the catalyst produces less coke than prior art catalysts, imparting improved selectivity in the products and facilitating a higher conversion operation.

In an FCC process, the catalyst particles become covered with coke as the oil feed is degraded to lighter fuel products on one hand and condensation of less reactive polymeric coke products on the other.

The fresh feed and recycle streams are preheated by heat exchangers or a furnace and enter the unit at the base of the feed riser where they are mixed with the hot regenerated catalyst. The heat from the catalyst vaporizes the feed and brings it up to the desired reaction temperature. The mixture of catalyst and hydrocarbon vapor travels up the riser into the reactors. The cracking reactions start when the feed contacts the hot catalyst in the riser and continues until the oil vapors are separated from the catalyst above the riser. The hydrocarbon vapors are sent to the synthetic crude fractionator for separation into liquid and gaseous products, and the catalyst proceeds to the stripper.

The catalyst leaving the reactor is called spent catalyst and contains hydrocarbons adsorbed on its internal and external surfaces as well as the coke deposited by the cracking reactions. Some of the adsorbed hydrocarbons are removed by steam stripping before the catalyst enters the regenerator. In the regenerator, coke is burned from the catalyst with air. Both process and catalysts are complex, and have been reviewed in a recent publication (J. S. Magee and M. M. Mitchell, Jr., “Fluid Catalytic Cracking: Science and Technology”, Studies in Surf. Sci. Catal., v. 76 (Elsevier, Amsterdam (1993)).

It is desirable to minimize coke production because coke blocks the active catalyst sites, reducing both the activity and selectivity of the catalyst. The nature of the process hardware is such that the limiting feature of the equipment is the so called “regenerator capacity”—the ability to fully “burn off” the coke to CO, CO₂ and H₂O in the regenerator. The process is therefore operated at a conversion capacity commensurate with the capacity of the regenerator to remove the coke within the air/oxygen and temperature limits of the regenerator. A catalyst that is more “coke selective” produces less coke per unit of oil feed and can therefore be run at higher feed conversion levels, thereby facilitating higher production rates. Such catalysts are particularly desirable when using lower cost “resid” feedstocks having inherently higher coke yields. Alternatively the unit requires less fresh catalyst to be added to maintain the same production level.

### SUMMARY OF THE INVENTION

The present invention is a coke selective catalyst and process for using it in a fluidized-bed catalytic cracking unit. The catalyst(s) is a metal deficient framework having a substantially ordered distribution of reaction sites. The catalyst is contacted with a hydrocarbon feedstream in fluidized-bed catalytic cracking unit which provides superior carbon selectivity thereby minimizing coke production and maximizing conversion efficiency. While not to be bound by particular theories or mechanisms, it is believed that the superior performance is related to the ordered state of the residual Al acid sites, whereas in conventional materials the Al aggregates into oxide clusters in the large mesopores, so forming non-selective Lewis acid centers which promote coke formation.

### BRIEF DESCRIPTION OF DRAWING

FIG. 1 compares the typical pore size distribution of the materials of this invention compared with prior art commercial samples. The maintenance of micropores and a high proportion of super-micropores is clearly visible in the materials of this invention.

### DESCRIPTION OF THE PREFERRED EMBODIMENT

The present invention requires a catalyst zeolite component having a substantially ordered distribution of reaction sites, a low number of sites (preferably less than 10% based on total T (tetrahedral sites)), and a pore volume in “super micropores” equal or greater than the pore volume in mesopores. For the purposes of this invention the term “super micropores” means pores having diameters in the range of 15 to 50 Å and mesopores are pores having diameters in the range 50-500 Å, as measured by conventional gas sorption methods well known in the art (e.g. ASTM Method D4641 is a typical method). Such values relate to the zeolite and not to the matrix components, the latter being independently varied.

The catalyst may be prepared by substituting a metal, M, into the framework sites (T-sites) of a crystalline metal molecular sieve material during its synthesis and then demetallating it as described in U.S. Pat. No. 5,308,813. Surprisingly, these materials have superior coke selectivity in FCC processing.

In the present invention, extended treatments and manipulation of process conditions can additionally remove Al³⁺ from the lattice, generating significant super microporosity and mesoporosity in stable materials. These “soft chemistry” products prove to be excellent FCC catalyst promoters, quite compatible with ‘state of the art’ commercial catalysts made using “hard” and “soft” chemistry processes, without the disadvantages of prior art materials. These represent a new generic group of catalysts by virtue of their more uniform Al distributions and high level of “super micropores” rather than large mesopores. They do not require the high temperature steam pretreatment (and its attendant high cost) to achieve the same Si/Al ratio and therefore activity level.

Briefly, the process comprises the following steps:

Synthesis of the metallo-aluminosilicate, followed if a template is used in the synthesis, by template removal, usually by calcination in air or oxygen.

Solution demetallation at up to 250° C., or mild metal hydrolysis (usually below a temperature of 600° C.) followed by low temperature extraction of the metal, M.

Optionally partial dealumination (this may be done simultaneously or subsequently to the previous step).

Cation exchange to remove residual base cation(s) to acceptable levels, and replace them preferentially with Al³⁺ rare-earth cations, NH₄⁻or H⁺.

Catalyst formulation and fabrication by mixing with one or more matrix components and spray drying.

Formulation and fabrication of the catalyst may be achieved using any of the available techniques well known in the art. Diluent or matrix binder components may include those well known in the art, such as naturally occurring or synthetic inorganic oxides (typically, silica, alumina titania, zirconia, boria, P₂O₅, and mixtures thereof) and hydroxides in the form of particulates, sols, gels or cogels of same, and virgin or modified clays, and pillared layered compounds as reviewed by Vaughan (Amer. Chem. Soc. Symp. Ser. #368, p. 308-323 (1988)) and Ohtsuka (Chem. Materials, v. 9, p. 2039-50 (1997)), included herein by reference. While recognizing that the rare-earths include elements having atomic numbers between 57 (La) and 71 (Lu), lower cost commercial rare-earth solutions comprise mainly mixtures of these with La, Ce and Nd being the major components. If used individually La³⁺may be the preferred exchange rare-earth cation. Zeolites may also be used as binder or cocatalysts with these materials.

The catalyst may be formed by any of the methods well known in the art, but spray drying is the preferred method as it is the cheapest way to make the desired 20-150 micron particles used in FCC.

The dealumination of faujasite (commercial products include US-Y, LZ-210, LZY-82, CBV types) and other zeolites is a long established practice in the catalyst industry to enhance the stability and moderate the catalytic activity of zeolite catalysts, particularly promoters in the faujasite family of FCC and hydrocracking catalysts (see Scherzer, Amer. Chem. Soc. Symp. Ser. #248, Ch. 10 (1984): Catal. Rev., 31, 215 (1989), for an extensive review of this subject). Invariably the aluminosilicate form of the Y zeolite is used as the starting material and the objective in preparing US-Y materials is to enhance the stability of the zeolite, and to moderate its catalytic activity which is generally proportional to the level of Al³⁺ in the framework sites of the zeolite. There is also incidental development of mesopores caused by the random and uncontrolled hydrolysis of aluminum from the zeolite lattice, followed by collapse and solubilization of parts of the zeolite crystals during a high temperature steaming process. These pores are further expanded by sequential dealumination treatments, such as post acid washes, and catalyst regeneration involving high temperature steam. The resulting materials have a random distribution of mesoporosity in the form of pores and channels in the crystals up to tens of nanometers in diameter (Dai et al, Amer. Chem. Soc. Petr. Prepr., 38(3), 594 (1993); Addison et al, Appl. Catal., 45 307 (1988); Lohse and Mildebrath, Z. anorg. Allg. Chemie, 476, 126 (1981)) in addition to retained zeolitic microporosity.

Most materials of this type are made by ammonium exchanging Na-Y forms of faujasite, then steaming them at high temperatures (6-800° C.) for several hours - a so-called “hard chemistry” approach. Much of the recent art has sought to enhance Si/Al ratios of zeolite Y by “soft chemical” low temperature “framework exchange” procedures which produce few mesopores, as demonstrated faujasites of the LZ-210 variety (Skeels and Breck, Proc. 6th Intl. Zeolite Conf., Ed. Olson and Bisio, 87 (1984); Breck and Skeels, U.S. Pat. No. 4,503,023; Rees and Lee, Intl. Pat. Appl. WO-8801254). These procedures use highly corrosive solutions of chloride and fluoride salts of silicon at between room temperature and 100° C. Such processes also randomly remove Al³⁺ from the zeolite framework and leave residual halide on the zeolite to give unit corrosion problems in subsequent processing.

In short, the drawbacks which impair optimum selectivities in current FCC catalysts are primarily:

detrital Al species (AlO+, Al(OH)_{X}^{(3-X)+}, Al₂O₃ clusters, etc.) deposited throughout the retained crystalline and non-crystalline pore structure which act as non-selective catalytic sites and block micropores.

non-uniform framework Al distributions, especially preferred leaching from crystal surfaces, particularly when using bulky extractants showing ion-sieve properties.

less retained crystalline structure indicated by the lower micropore volume.

residual halide (Cl, F) when halides are used as extractants, (e.g. (NH₄)₂SiF₆) creating corrosion problems in reactor and regenerator units.

excessively large mesopores - greater than 100 Å-in highly dealuminated materials - produced in the high temperature steam process characteristic of US-Y materials.

In comparison, the new method described in this report produces a demetallated material with ordered defects (which can be filled later if desired) and acid sites and negligible detrital aluminum. The demetallation procedures described below result in a preponderance of small mesopores or large micropores (designated “super-micropores” for the purpose of this invention), in the range of 15Å to 50Å. This pore size range has been shown to have desirable mid-distillate selectivities in amorphous silica-alumina materials (British Patent 1483466).

Although various faujasites are the primary molecular sieve zeolite catalysts used in FCC this method is equally applicable to other related primary FCC promoters such as ECR-30 (BSS, EMT), ECR-35, ZSM-2,3 or 20, CSZ-2 and related materials (see Treacy et al. For a fuller description in Proc. Roy. Soc. A, v. 452, p. 813-60 (1996)), and other 12-ring molecular sieves such as beta, LTL, mordenite, etc., and to secondary promoters such as those represented by structure codes MFI, MEL, FER, TON, MTW, EUO and like materials, as described by Meier et al. (Zeolites, v. 17 (1/2) (1996).

We have recently shown that it is possible to selectively remove the metal M from the framework without removing the Al (U.S. Pat. No. 5,308,813). In the present invention we further show that by using a more aggressive reactant Al can be sequentially selectively removed, resulting in the formation of super micropores in the zeolite crystals with attendant retention of high levels of zeolite micropore structure. We have further discovered that when used in FCC these materials have superior carbon selectivity over prior art catalysts. Not to be bound by any rigid mechanisms, we believe that the important and key differences include the ordered nature of the residual acid sites (framework Al³⁺), negligible non-selective detrital alumina and a high content of “super-micropores”.

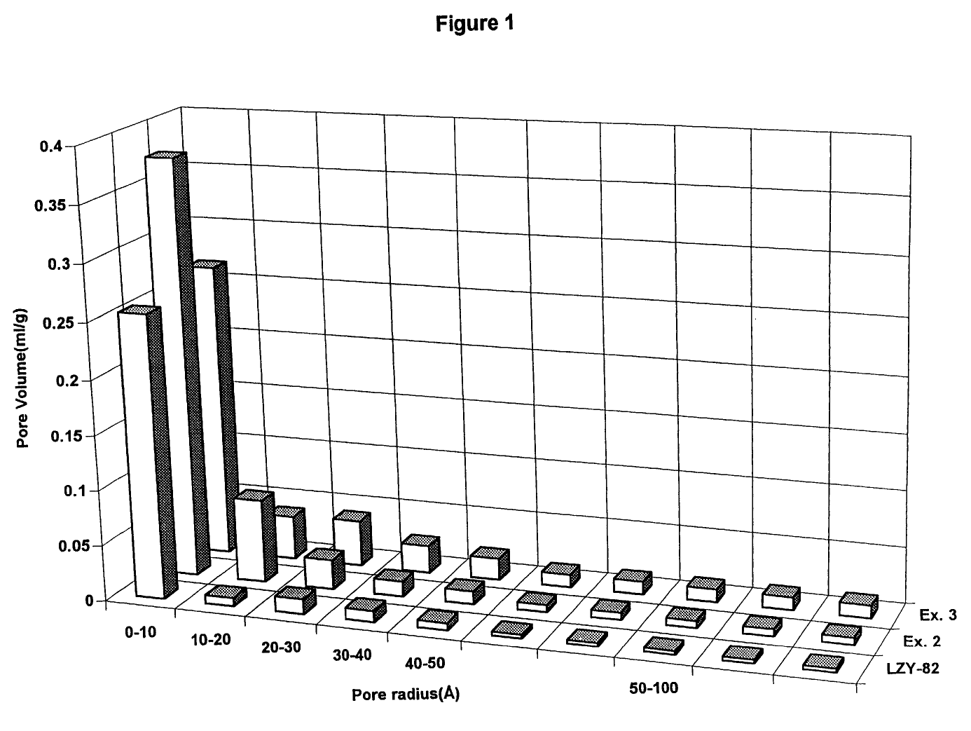

FIG. 1 compares the typical pore size distribution of the materials of this invention compared with prior art commercial samples. The maintenance of micropores and a high proportion of super-micropores is clearly visible in the materials of this invention.

### EXAMPLE 1

A Fe-ECR-32 with 0.25 Fe:(Al+Fe) ratio was prepared using modified well known synthesis procedures (Vaughan et al., U.S. Pat. No. 4,931,267). A gel of composition:

3.6(TPA)₂O:1.2Na₂O:(0.25Fe,0.75 Al)₂O₃:18SiO₂:275H₂O

was prepared using 10% seeding level and reacted at 125° C. for three days. The product was recovered by filtration and washed with distilled water and dried in an 115° C. oven. Powder X-ray diffraction (XRD) analysis showed the product to be excellent ECR-32. Elemental analysis gave: 4.38% Al; 2.98% Fe; 3.78% Na and 26.5% Si, which is a Si/(Al+Fe) ratio of 4.37 and an Si/Al ratio of 5.8. After calcination in air at 625° C. to remove the organic template, this sample adsorbed 17.7% n-hexane at 50 torr and 24° C. A 10 g (.0216 moles of Al+Fe) sample of this Fe ECR-32 was then slurried in 150 ml distilled water in a 500 ml round bottom flask and then connected to a soxhlet extraction apparatus. The thimble was charged with 3.15 g. H₄EDTA (.012 moles) and allowed to slowly extract into the zeolite mixture for a period of 24 hours. The product was filtered, washed with distilled water and then dried in 115° C. oven. After four exchanges with 10% NH₄Cl solutions, elemental analysis gave: 2.78% Al; .12% Fe; .01% Na; and 35.8% Si, which is a Si/(Al+Fe) ratio of 12.1. Clearly this process had not only removed almost all of the Fe³⁺but also half of the Al³⁺. This sample sorbed 18.6% n-hexane at 50 torr and 23° C. after outgassing at 400° C. under vacuum. To investigate the effects of FCC regeneration a portion of this EDTA treated material was steamed (100% steam) at 1250° F. for 5 hours. This steamed sample sorbed 12.5% n-hexane at 50 torr and 23° C. after outgassing at 400° C. under vacuum. This sample was subsequently converted into a cracking catalyst containing 30% wt. zeolite by mixing together into a thick slurry: 2.1 gm. zeolite (dry basis), 3.8 gm. colloidal silica (DuPont Ludox HS-40), 3.55 gm. kaolin clay (Ga Kaolin Hydrite UF grade) and 30 gm. distilled water. This was de-watered on a hot plate with stirring until it formed a paste, then it was oven dried in flowing air at 120° C. followed by calcination for three hours at 350° C. The hard composite was then crushed and sieved to −100 to +40 mesh. This FCC catalyst was then tested in a standard FCC micro-activity test (ASTM D3907;3C/O;16 WHSV;980° F.) after steaming at 1400° F. for 5 hours in 100% stream and using a high sulfur gasoil as feed (Table 1). The results are compared with a commercial regenerated US-Y catalyst (Grace-Davison Octacat D), treated in a similar manner to give a comparative activity, in Table 2. As expected, the high silica promoter of this invention has lower intrinsic activity by virtue of fewer Al acid sites. The catalyst of this invention is quite comparable with the commercial catalyst fuel yields but additionally shows much improved coke selectivity and enhanced light olefin yields. The 45% improvement in coke selectivity would allow the unit to increase higher capacity or alternatively add less fresh catalyst to maintain the same activity.

TABLE 1
GAS OIL FEEDSTOCK PROPERTIES
F90-2 HSGO

| A.P.I. GRAVITY | 21.4 @ 60 F |
|---|---|
| ANILINE POINT | 168 F |
| CARBON RESIDUE | 0.20% BY MASS |
| NICKEL, WT % | 0.21% |
| VANADIUM, WT | 0.00% |
| SULFUR, WT % | 2.65% |
| CARBON, WT % | 85.5% |
| HYDROGEN, WT % | 12.2% |

ASTM D-1160 DISTILLATION RESULTS

| VOLUME % | DEGREES F. |
|---|---|
| 5% | 596 |
| 10% | 616 |
| 20% | 640 |
| 30% | 663 |
| 40% | 687 |
| 50% | 707 |
| 60% | 729 |
| 70% | 751 |
| 80% | 782 |
| 90% | 820 |
| 95% | — |
| END POINT | 828 |

TABLE 2

| | Octacat D | Example 1 |
|---|---|---|
| C/O | 3.02 | 3.002 |
| WHSV | 15.91 | 15.990 |
| CONV. WT % | 54.59 | 54.429 |
| HYDROGEN WT % | 0.06 | 0.093 |
| DRY GAS WT % | 2.18 | 2.131 |
| C1 WT % | 0.70 | 0.664 |
| C2 WT % | 0.76 | 0.675 |
| C2 = WT % | 0.73 | 0.792 |
| TOTAL C3 WT % | 4.06 | 5.462 |
| C3 WT % | 1.00 | 1.036 |
| C3 = WT % | 3.87 | 4.426 |
| TOTAL C4 WT % | 8.27 | 8.668 |
| IC4 WT % | 2.69 | 2.924 |
| TOTAL C4 = WT % | 4.92 | 5.107 |
| NC4 WT % | 0.66 | 0.637 |
| C5 + GASOLINE WT % | 35.51 | 35.527 |
| C5 + GASOLINE./CONV. | 0.65 | 0.653 |
| LCO WT % | 21.66 | 20.576 |
| HCO WT % | 23.75 | 24.994 |
| COKE WT % | 3.70 | 2.550 |
| WT % REC. | 99.25 | 99.394 |

### EXAMPLE 2

A gallium aluminosilicate faujasite of the Y type was prepared using modified well known synthesis procedures (Vaughan et al, Proc. 7th Intl. Zeolite Conf., p. 207, (1989); Amer. Chem. Soc., Symp. Ser. #218, p. 231 (1983)). A gel of Stoichiometry:

3Na₂O:(0.33Ga,0.67 Al)₂O₃:9SiO₂:140H₂O:0.86Na₂SO₄

was prepared using a 2% seeding level and reacted for 23 hours at 100° C. The product was recovered by filtration and washed with distilled water and dried in an 115° C. oven. Powder X-ray diffraction (XRD) analysis showed the product to be excellent faujasite. Elemental analysis gave:5.77% Al;7.43% Ga;7.18% Na and 21.4% Si, which is a Si/(Al+Ga) ratio of 2.38 and Si/Al ratio of 3.56. This sample sorbed 18.4% n-hexane at 51 torr slurried in 300 ml distilled water in a 500 ml round bottom flask and then connected to a soxhlet extraction apparatus. The thimble was charged with 9.5 g H4EDTA(.032 moles) and allowed to slowly extract into the zeolite mixture for a period of 48 hours. The product was filtered, washed with distilled water and then dried in 115° C. oven. Elemental analysis gave:5.43% Al;.566% Ga;4.72% Na; and 27.0% Si, which represents a Si/(Al +Ga) ratio of 4.59 and Si/Al =4.77 indicating Al removal in addition to Ga removal. This material was then ammonium exchanged as described in Example 1. This sample adsorbed 23.8% n-hexane at 50 torr and 23° C. after outgassing at 400° C. under vacuum. The pore size distribution was measured using the method of Barrett, Joyner and Halenda (J. Amer. Chem. Soc., 73, p. 373-380, 1951) which is based upon applying the Kelvin equation of capillary condensation to the nitrogen desorption isotherm. The mesopore size distribution along with the micropore volume (radii <10Å) was determined from analysis of the T-plot (Lippens and de Boer, J. Catalysis, 4, p. 319-323, 1965). FIG. 1 compares the nitrogen pore size distribution of this example with a typical steamed commercial US-Y (LZY-82 from UOP/Union Carbide Corp.), the former showing a strong graded component in the mesopore range in addition to the retained zeolite micropore volume. Both the product of this example and a sample of commercial LZY-82 were converted to identically loaded catalysts as described in Example 1, steamed at 1400° F. for 5 hours, then microactivity tested using the ASTM D3907 procedure (3 C/O; 16 WHSV; 980° F.) and the high sulfur gasoil feedstock described in Table 1. The results presented in Table 3 show that at comparable activity levels the product of this invention has a 17% improved light olefin and coke selectivities, that can be translated to higher barrels/day processed or lower catalyst additions.

### EXAMPLE 3

An iron alumninosilicate faujasite of the Y type was prepared using a modified well known synthesis procedure referenced in Example 2. A gel of stoichiometry:

4Na₂O:(0.33Fe,0.67Al)₂O₃:12SiO₂:187H₂O

was prepared using a 5% seeding level and reacted for 43 hours at 100° C. The product was recovered by filtration and washed with distilled water and dried in an 115° C. oven. Powder X-ray diffraction (XRD) analysis showed the product to be excellent faujasite. Elemental analysis gave:5.59% Al;5.80% Fe;8.33% Na and 24.9% Si, which is a Si/(Al+Fe) ratio of 2.85 and an Si/Al ratio of 4.28. This sample sorbed 15.0% n-hexane at 50 torr and 23° C. after outgassing at 400° C. under vacuum. A 20 gram portion of this sample (.062 moles of Fe+Al) was slurried in 300 ml distilled water in a 500 ml round bottom flask and then connected to a soxhlet extraction apparatus. The thimble was charged with 9.1 g H₄EDTA (.032 moles) and allowed to slowly extract into the zeolite mixture for a period of 2 days. The product was filtered, washed with distilled water and then dried in 115° C. oven. Elemental analysis gave:5.01% Al;.144Fe;4.25% Na; and 30.3% Si, which represents a Si/(Al+Fe) ratio of 5.73 and an Si/Al ratio of 5.8 indicating that Al had been removed in addition to Fe. This material was then exchanged with ammonium ion to a low sodium level as described in Example 1. This sample sorbed 16.9% n-hexane at 50 torr at 23° C. after outgassing at 400° C. under vacuum. The pore size distribution was measured using the desorption branch of the nitrogen isotherm at −770C. The mesopore size distribution along with the micropore volume (radii<10Å) determined from analysis of the T-plot is shown in FIG. 1 and clearly shows the increased super microporosity of the EDTA treated FeFAU material over a conventional LZ-Y82 material.

The product of this example was converted to a 30% zeolite loaded catalyst in the manner described in Example 1, steamed at 1400° F. for 5 hours, then microactivity tested using the ASTM D3907 procedure (3C/O;16 WHSV; 980° F.) and the high sulfur gasoil feedstock described in Table 1. The results presented in Table 4 compare it with a US-Y commercial catalyst (Grace/Davison Octacat D) steam deactivated to a similar conversion level. They again show that the product of this invention has improved coke and light olefin selectivities. The 30% improvement in coke selectivity can be converted to higher unit throughput or lower catalyst addition.

TABLE 3

| | LZY-82 | Example 2 |
|---|---|---|
| C/O | 2.9 | 3.0 |
| WHSV | 16.5 | 16.0 |
| CONV. WT % | 68.48 | 69.56 |
| H2 WT % | 0.08 | 0.10 |
| DRY GAS WT % | 1.42 | 3.28 |
| TOTAL C3 WT % | 5.35 | 7.32 |
| C3 = WT % | 4.16 | 5.19 |
| TOTAL C4 WT % | 10.05 | 11.70 |
| IC4 WT % | 4.68 | 5.35 |
| C4 = WT % | 4.5 | 4.94 |
| C5 + GASOLINE WT % | 46.53 | 42.85 |
| C5 + GASOLINE/CONV. | 0.68 | 0.62 |
| LCO WT % | 21.45 | 18.65 |
| HCO WT % | 9.57 | 11.79 |
| COKE WT % | 5.06 | 4.32 |
| REC WT % | 100.7 | 99.6 |

TABLE 4

| | Example 3 | Octacat D |
|---|---|---|
| C/O | 2.985 | 2.961 |
| WHSV | 16.079 | 16.210 |
| CONV WT % | 58.316 | 61.590 |
| H₂ WT % | 0.079 | 0.082 |
| DRY GAS WT % | 2.391 | 3.345 |
| METHANE WT % | 0.758 | 0.740 |
| ETHANE WT % | 0.776 | 1.665 |
| ETHYLENE WT % | 0.856 | 0.939 |
| TOTAL C3 WT % | 5.966 | 6.439 |
| PROPANE WT % | 1.255 | 1.375 |
| C3 = WT % | 4.711 | 5.064 |
| TOTAL C4 WT % | 9.334 | 10.658 |
| IC4 WT % | 3.164 | 4.270 |
| TOTAL C4 = WT % | 5.401 | 5.453 |
| NC4 WT % | 0.769 | 0.935 |
| C5 + GASOLINE WT % | 37.366 | 36.936 |
| C5 + GASOLINE/CONV. | 0.641 | 0.600 |
| LCO WT % | 20.267 | 19.445 |
| HCO WT % | 21.416 | 18.966 |
| COKE WT % | 3.181 | 4.129 |
| REC WT % | 99.946 | 99.059 |

The products of this invention show improved coke and light olefin and gas selectivities whilst retaining gasoline and distillate selectivities over a range of conversion levels. We ascribe this to a more uniform distribution of Al in the crystalline zeolite, little detrital material in the pores and the desirability of super micropores and small mesopores rather than the large mesopores found in prior art materials. The ability to make these catalysts at low temperature without steaming provides an important control on the pore distribution and degree of demetallation of the catalyst promoter.

What is claimed is:

1. A process for converting a hydrocarbon feedstream by a catalytic reaction in a catalytic cracking process comprising contacting said feedstream with a demetallated molecular sieve catalyst prepared by
a) first synthesizing the molecular sieve in a metal aluminosilicate form, wherein the metal is Fe, Ga, Zn, B, Cr, Ni or Co and mixtures thereof;
b) removal of the template, if present, by calcination;
c) extracting the metal, with partial extraction of Al;
d) cation exchange to reduce the residual base cation level to less than 1% wt;
e) catalyst fabrication by mixing said exchanged molecular sieve, optionally adding a secondary promoter, with a binder and forming.

2. A coke selective catalyst of claim 1 comprising a crystalline molecular sieve material having a metal deficient framework wherein the residual framework Al sites constitute less than 20% of the total T-sites.

3. A coke selective catalyst of claim 1 comprising a crystalline molecular sieve material having a metal deficient framework wherein residual Al constitutes less than 10% of the total T-sites.

4. A catalyst of claim 1 wherein the molecular sieve has a faujasite (FAU) structure.

5. A catalyst of claim 1 wherein the metal substituent is Fe, Zn, Ga or mixtures thereof.

6. The catalyst of claim 1 wherein the cation exchange is carried out using solutions of Al³⁺, rare-earths, NH₄⁺, H⁺or mixtures thereof.
